(19) United States
(12) Patent Application Publication
(10) Pub. No.: US 2004/0123312 A1
(43) Pub. Date: Jun. 24, 2004

(54) Contents distributing method via a communications network

(75) Inventor: Masaya Kimura, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/636,761

(22) Filed: Aug. 8, 2003

(30) Foreign Application Priority Data
Aug. 16, 2002 (JP) 2002-237356

(51) Int. Cl. H04N 7/10; H04N 7/025; H04N 7/167; H04N 7/16

(52) U.S. Cl. 725/31; 725/36; 725/25

(57) ABSTRACT

Encrypted contents information is received by a contents information receiving unit, and stored by a first storing unit. Each time a request to output stored contents information is input in a contents outputting device, a distribution request for a decryption key required to decrypt the contents information is transmitted from a key distribution request transmitting unit. A key receiving unit receives the decryption key transmitted in response to this request, and an encryption key used to perform an encryption process, which cannot be decrypted with the decryption key, for the contents information. A contents outputting unit decrypts and outputs the contents information. After the contents information is output, the encryption process using the encryption key, which is received along with the decryption key, is performed for the contents information by an encryption processing unit, and the contents information is again stored by a second storing unit.

### BACKGROUND OF THE INVENTION

1. Field of the Invention

The present invention relates to a technique distributing information via a communications network, and more particularly, to a technique suppressing the reuse of distributed information.

2. Description of the Related Art

For broadcasting such as TV broadcasting, etc., its normal form is where contents is transmitted from a broadcasting station in real time, and a viewer watches the transmitted contents in real time. Since it is difficult for the viewer to watch the contents while omitting an advertisement broadcast by being included in the contents, a high advertising effectiveness can be expected from the broadcasting, and an advertiser (sponsor) can increase the sales of a commodity product, etc. In the meantime, the broadcasting station can earn a high advertisement fee, and can make a watching charge free due to this earning.

For contents distribution made by using a communications network such as the Internet, etc., it is a more normal form where entire contents is distributed and once stored on the side of a viewer, and the stored contents is viewed by the viewer. In this form, the contents can be viewed while omitting an advertisement included in the contents. Therefore, a high advertising effectiveness cannot be expected from an advertisement distribution made with a method similar to the above described one, and it is difficult for a contents distributor to earn a high advertisement fee from an advertiser. In addition, since contents is stored, a viewer can repeatedly view the same contents with ease. Therefore, a distributor cannot help collecting some watching charge, and it is not easy to make the watching charge free.

To prevent distributed contents from being repeatedly viewed, Japanese Patent Publication No. 7-162408 discloses a technique with which a pair of key data is generated in a data provider side device, data to be distributed is encrypted with one of the key data and stored in a data user side device, the data is then decrypted with the other of the key data which is transferred as a decryption key to the data user side device in response to a request to use the stored data, the decrypted data is encrypted with one out of a pair of key data newly generated in the data provider side device, and the decrypted data is again stored in the data user side device.

Additionally, Japanese Patent Publication No. 2000-268096 discloses a technique with which licensing/copyright information is presented to a user prior to contents, which is allowed to be viewed on the condition that user content is obtained, and a server side verifies/assures that the contents has been distributed completely from the server side. With this technique, the server first generates a contents file that includes encrypted contents data and content information, and transmits the contents file, which corresponds to the contents specified by a distribution request made from a user terminal, to the user terminal. The user terminal presents the content information included in the received contents file to the user, obtains user content to the description of the content information, and transmits a decryption request including the content information to the server in accordance with the content. The server then verifies the content information, and returns a decryption permission including key information for decrypting the encrypted contents data if a verification result is legal. The user decrypts the encrypted contents data on the user terminal, so that he or she can view the contents.

Furthermore, Japanese Patent Publication No. 2001-147970 discloses a technique with which contents distribution itself is made at no charge, and a replay of the contents is charged. With this technique, view right data, which accrues the right to view contents by means of authentication and encryption/decryption between a user terminal and a distribution server, is safely passed to the user terminal, and view history information is transferred from the user terminal if the right to view contents is sold to the user.

### SUMMARY OF THE INVENTION

The present invention is especially useful in a business model which obtains an advertisement fee higher than a normal one from an advertiser to earn a profit by obtaining a higher advertising effectiveness when contents including an advertisement is distributed using a communications network. An object of the present invention is to suppress a repetitive output of contents in contents information distribution using a communications network, and to give a user a motivation to actively output an advertisement distributed along with the contents, in view of the above described circumstances.

A contents distributing method in one aspect of the present invention comprises: transmitting, to a communications network, contents information which represents contents and is encrypted with an encryption key; transmitting, to the communications network, an encryption key used to perform an encryption process, which cannot be decrypted with a decryption key, for the contents information along with the decryption key requested by a distribution request in response to the distribution request for the decryption key required to decrypt the encrypted contents information; and transmitting, to the communications network, an encryption key used to perform an encryption process, which cannot be decrypted with a decryption key, for the contents information along with the decryption key requested by a distribution request, each time information indicating the distribution request for the decryption key required to decrypt the contents information, for which the encryption process is performed with the encryption key transmitted to the communications network, is received. At this time, an encryption process using the encryption key, which is received from the communications network along with the decryption key, is again performed for the contents information transmitted to the communications network, and the contents information is stored in a reception terminal, after the contents information is decrypted with the decryption key received from the communications network, and output in the reception terminal which receives the contents information.

A contents outputting method in another aspect of the present invention is a method outputting contents distributed with the above described method, and comprises: receiving, from a communications network, contents information which represents contents and is encrypted with an encryption key; storing the received encrypted contents information; transmitting, to the communications network, distribution request information indicating a distribution request for a decryption key required to decrypt the contents information, each time a request to output the stored contents information is input; receiving, from the communications network, the decryption key which is requested by the distribution request information and transmitted in response to the distribution request information, and an encryption key used to perform an encryption process, which cannot be decrypted with the decryption key, for the contents information; decrypting the encrypted contents information with the decryption key transmitted in response to the distribution request information, and outputting the contents information; performing an encryption process for the contents information with the encryption key, which is received along with the decryption key transmitted in response to the distribution request information, after the contents information is output; and again storing the contents information for which the encryption process is performed.

In this way, an encryption process using a new encryption key is performed for contents information after the contents information is output. Accordingly, each time the same contents information is repeatedly output, a contents user must transmit distribution request information indicating a distribution request for a decryption key to a communications network by inputting a request to output the contents information, receive the decryption key transmitted in response to the distribution request information, and decrypt the contents information with the received decryption key. Some processing time is required for a series of processes performed from an input of the request to output contents information until an output of the contents information. Furthermore, the contents user is forced to make the request to output contents information each time, so that the contents user feels troublesome. To free from this troublesomeness, a repetitive output of the contents information may be avoided. Consequently, the repetitive output of the contents information is suppressed.

A contents distributing method in a further aspect of the present invention comprises: transmitting, to a communications network, contents information and advertisement information which respectively represent contents and an advertisement, and are encrypted with an encryption key; and transmitting, to the communications network, an encryption key used to perform an encryption process, which cannot be decrypted with a decryption key, for the contents information and the advertisement information along with the decryption key requested by a distribution request in response to the distribution request for the decryption key required to decrypt the encrypted contents information and advertisement information. At this time, an encryption process using the encryption key, which is received from the communications network along with the decryption key, is repeatedly performed by the number of times, which corresponds to the number of repetition times that the contents information is output, for the contents information and the advertisement information, which are transmitted to the communications network, and the encrypted contents information and advertisement information are stored, after the contents information and the advertisement information are decrypted with the decryption key received from the communications network, and the contents information is output in a reception terminal which receives the contents information and the advertisement information. In the reception terminal, the advertisement information is output, and the number of repetition times when the encryption process is repeatedly performed for the contents information is reduced, when an instruction to allow the advertisement information to be output is input.

A contents outputting method in a still further aspect of the present invention is a method outputting contents distributed with the above described method, and comprises: receiving, from a communications network, contents information and advertisement information which respectively represent contents and an advertisement, and are encrypted with an encryption key; storing the received encrypted contents information and advertisement information; transmitting, to the communications network, distribution request information indicating a distribution request for a decryption key required to decrypt the stored contents information and advertisement information; receiving, from the communications network, the decryption key which is requested by the distribution request information and transmitted in response to the distribution request information, and an encryption key used to perform an encryption process, which cannot be decrypted with the decryption key, for the contents information; decrypting the encrypted contents information with the decryption key transmitted in response to the distribution request information, and outputting the contents information; repeatedly performing an encryption process with the encryption key, which is received along with the decryption key, for the contents information by the number of times, which corresponds to the number of repetition times that the contents information is output, after the contents information is output; and again storing the contents information for which the encryption process is performed. At this time, the advertisement information is output, and the number of repetition times that the encryption process is performed for the contents information is reduced, when an instruction to allow the advertisement information to be output is input.

With this configuration, an encryption process is performed for contents information by the number of times, which corresponds to the number of repetition times that the contents information is output, after the contents information is output. Therefore, decryption must be repeated to output the contents information, so that a lot of processing time is required to decrypt the contents information. As a result, troublesomeness that a contents user feels grows with an increase in the number of repetition times that the contents information is output, whereby a suppression effect of the repetitive output of contents information can be enhanced.

In the meantime, the contents user issues an instruction to output advertisement information, whereby the number of repetition times that the encryption process is performed for the contents information is decreased. In this case, also the number of repetition times of decryption required to output the contents information is decreased. Therefore, the processing time required to decrypt the contents information is reduced, so that also the troublesomeness that the contents user feels is alleviated. Accordingly, the contents user will actively issue the instruction to output advertisement information so as to alleviate his or her feeling of troublesomeness. Namely, with this configuration, a motivation to actively output an advertisement can be given to a contents user.

### BRIEF DESCRIPTION OF THE DRAWINGS

The present invention will be more apparent from the following detailed description when the accompanying drawings are referenced.

FIG. 1 is a schematic diagram showing the configuration of a first principle according to the present invention;

FIG. 2 is a schematic diagram showing the configuration of a second principle according to the present invention;

FIG. 3 is a block diagram showing the entire configuration of a system implementing the present invention;

FIG. 4 is a block diagram showing the configuration of a contents provider system;

FIG. 5 shows the configuration of a contents user system;

FIG. 6 is a block diagram showing the hardware configuration of a computer system which implements the contents provider system and the contents user system;

FIG. 7 shows the details of a contents distribution/provision process performed by the contents provider system and the contents user system;

FIG. 8A shows the data structure of a storage file for contents/advertisement data;

FIG. 8B shows the data structure of a contents provider side encryption key/decryption key management table;

FIG. 8C shows the data structure of a contents user encryption key/decryption key management table;

FIG. 8D shows the data structure of a contents user decryption times management table;

FIG. 9 shows the details of a charge information generation process performed by the contents provider system and the contents user system; and

FIG. 10 exemplifies computer-readable storage media on which is recorded a control program.

### DESCRIPTION OF THE PREFERRED EMBODIMENTS

A preferred embodiment according to the present invention is described below with reference to the drawings.

First of all, the principle of the present invention is described.

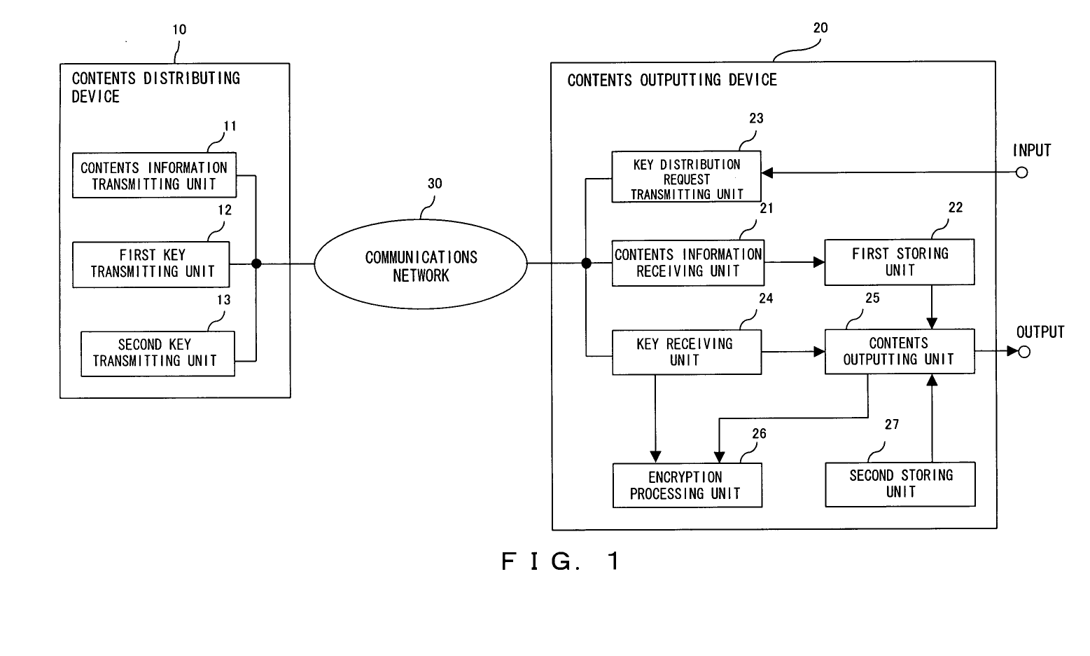

FIG. 1 is a schematic diagram showing the configuration of a first principle according to the present invention. In this figure, a contents distributing device 10 and a contents outputting device 20 are connected via a communications network 30, and can mutually transmit/receive various types of data. The communications network is, for example, the Internet.

Configuration of the contents distributing device 10 is described first.

A contents information transmitting unit 11 transmits, to the communications network 30, contents information which represents contents and is encrypted with an encryption key.

A first key transmitting unit 12 transmits, to the communications network 30, an encryption key used to perform an encryption process, which cannot be decrypted with a decryption key, for the contents information along with the decryption key requested by a distribution request in response to the distribution request for the decryption key required to decrypt the encrypted contents information.

A second key transmitting unit 13 transmits, to the communications network 30, an encryption key used to perform an encryption process, which cannot be decrypted with a decryption key, for the contents information along with the decryption key requested by a distribution request, each time information indicating the distribution request for the decryption key required to decrypt the contents information, for which the encryption process is performed with the encryption key transmitted to the communications network 30, is received.

Configuration of the contents outputting device 20 is described next.

A contents information receiving unit 21 receives, from the communications network 30, contents information which represents contents and is encrypted with an encryption key.

A first storing unit 22 stores the encrypted contents information which is received by the contents information receiving unit 21.

A key distribution request transmitting unit 23 transmits, to the communications network 30, information indicating a distribution request for a decryption key required to decrypt the contents information, each time a request to output the stored contents information in the contents outputting device 20 is input.

A key receiving unit 24 receives, from the communications network 30, the decryption key transmitted in response to information indicating the distribution request for the decryption key, which is transmitted from the key distribution request transmitting unit 23, and an encryption key used to perform an encryption process, which cannot be decrypted with the decryption key, for the contents information.

A contents outputting unit 25 decrypts the encrypted contents information with the decryption key transmitted in response to the information indicating the distribution request for the decryption key, and outputs the decrypted contents information.

An encryption processing unit 26 performs an encryption process for the contents information with the encryption key which is received along with the decryption key transmitted in response to the information indicating the distribution request for the decryption key, after the contents information is output from the contents outputting unit 25.

A second storing unit 27 again stores the contents information for which the encryption process is performed by the encryption processing unit 26.

With the configuration shown in FIG. 1, the encryption process is performed for contents information with a new encryption key by the encryption processing unit 26, after the contents information is output in the contents outputting device 20. Accordingly, each time the same contents information is repeatedly output, a contents user who uses the contents outputting device 20 must transmit, to the communications network 30, information indicating a distribution request for a decryption key by inputting a request to output the contents information, receive the decryption key transmitted from the contents distributing device 10, and decrypt the contents information with the decryption key. Some processing time is required for a series of processes from the input of the request to output contents information to the output of the contents information. In addition, a contents user is forced to input the request to output contents information each time. Therefore, the contents user feels troublesome. To free from the troublesomeness, a repetitive output of contents information may be avoided. As a result, the repetitive output of contents information is suppressed.

In the configuration shown in FIG. 1, if the output of contents information is repeated in the contents outputting device 20, the encryption processing unit 26 can perform an encryption process with the same encryption key by the number of times, which corresponds to the number of repetition times that the contents information is output. Additionally, if the contents outputting unit 25 outputs the contents information for which the encryption process is repeatedly performed, decryption can be repeated for the contents information with the same decryption key by the number of times, which corresponds to the number of repetition times of the encryption process.

With this configuration, the encryption process is performed for contents information by the number of times, which corresponds to the number of repetition times that the contents information is output, after the contents information is output in the contents outputting device 20. Therefore, decryption must be repeated to output this contents information, so that a lot of processing time is required to decrypt the contents information. As a result, the troublesomeness that a contents user feels further increases, whereby the effect of suppressing the repetitive output of contents information can be enhanced.

Here, when the contents information receiving unit 21 of the contents outputting device 20 receives encrypted contents information from the communications network 30, it can receive also advertisement information, which represents an advertisement and is corresponded to the contents information from the communications network 30. If an instruction to allow this advertisement information to be output is input to the contents outputting device 20, the contents outputting unit 25 can output the advertisement information, and at the same time, the number of repetition times that the encryption processing unit 26 performs the encryption process for the contents information can be reduced.

With this configuration, a contents user issues an instruction to output advertisement information to the contents outputting device 20, whereby the number of repetition times that the encryption processing unit 26 performs the encryption process for contents information is reduced. Since also the number of repetition times that the decryption required to output the contents information decreases, the processing time required to decrypt the contents information is reduced, and also the troublesomeness that the contents user feels is alleviated. Accordingly, the contents user will actively issue the instruction to output advertisement information so as to alleviate the feeling of troublesomeness. Namely, with this configuration, a motivation to actively output an advertisement can be given to a contents user.

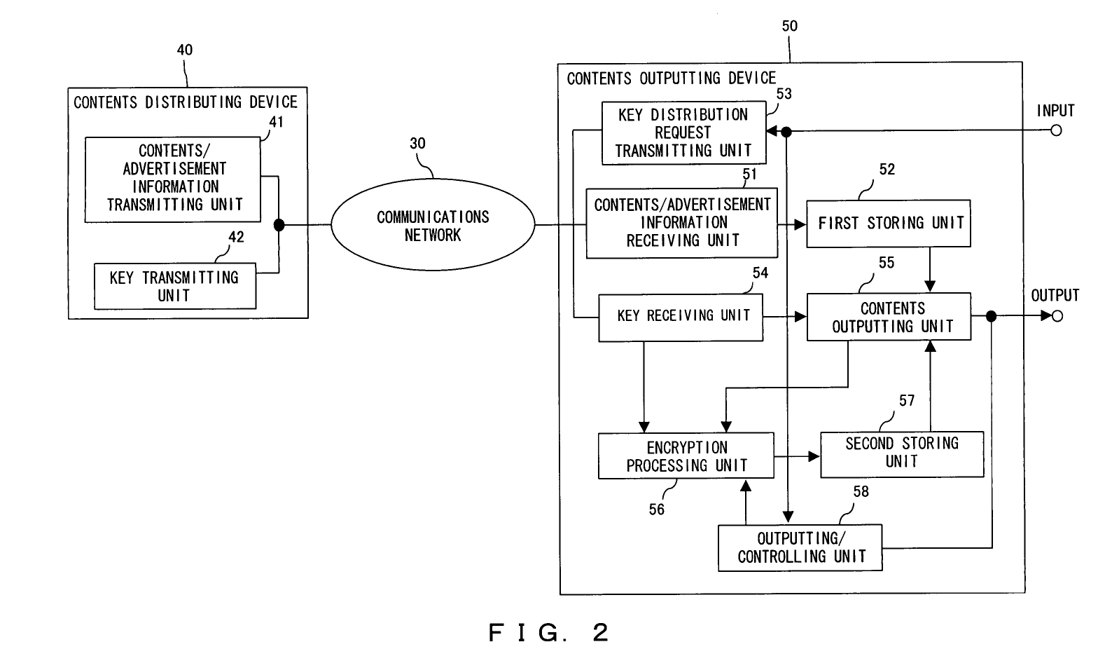

FIG. 2 is described next. This figure shows the configuration of a second principle according to the present invention.

In FIG. 2, a contents distributing device 40 and a contents outputting device 50 are connected via a communications network 30 similar to that shown in FIG. 1, and can mutually transmit/receive various types of data.

Configuration of the contents distributing device 40 is described first.

A contents/advertisement information transmitting unit 41 transmits, to the communications network 30, contents information and advertisement information which respectively represent contents and an advertisement, and are encrypted with an encryption key.

A key transmitting unit 42 transmits, to the communications network 30, an encryption key used to perform an encryption process, which cannot be decrypted with a decryption key, for the contents information and the advertisement information along with the decryption key requested by a distribution request in response to the distribution request for the decryption key required to decrypt the encrypted contents information and advertisement information.

Configuration of the contents outputting device 50 is described next.

A contents/advertisement information receiving unit 51 receives, from the communications network 30, contents information and advertisement information which respectively represent contents and an advertisement, and are encrypted with an encryption key.

A first storing unit 52 stores the encrypted contents information and advertisement information, which are received by the contents/advertisement information receiving unit 51.

A key distribution request transmitting unit 53 transmits, to the communications network 30, information indicating the distribution request for the decryption key required to decrypt the contents information and the advertisement information, which are stored in the contents outputting device 50.

A key receiving unit 54 receives, from the communications network 30, the decryption key that is requested by the information indicating the distribution request for the decryption key, which is transmitted from the key distribution request transmitting unit 53, and transmitted in response to the information, and an encryption key used to perform an encryption process, which cannot be decrypted with this decryption key, for the contents information.

A contents outputting unit 55 decrypts the encrypted contents information with the decryption key transmitted in response to the information indicating the distribution request for the decryption key, and outputs the decrypted contents information.

An encryption processing unit 56 repeatedly performs an encryption process using the encryption key, which is received along with the decryption key transmitted in response to the information indicating the distribution request for the decryption key, for the contents information by the number of times, which corresponds to the number of repetition times that the contents information is output, after the contents information is output from the contents outputting unit 55.

A second storing unit 57 again stores the contents information for which the encryption process is performed by the encryption processing unit 56.

If an instruction to allow the advertisement information to be output is input, an outputting/controlling unit 58 outputs the advertisement information, and reduces the number of repetition times that the encryption processing unit 56 performs the encryption process for the contents information.

With this configuration, the encryption process is performed for contents information by the number of times, which corresponds to the number of repetition times that the contents information is output, after the contents information is output in the contents outputting device 50. Therefore, decryption must be repeated to output this contents information, whereby a lot of processing time is required to decrypt the contents information. As a result, troublesomeness that the contents user feels grows with an increase in the number of repetition times that the contents information is output, so that the effect of suppressing the repetitive output of contents information can be enhanced.

In the meantime, the contents user issues an instruction to output the advertisement information to the contents outputting device 50, whereby the number of repetition times that the encryption processing unit 56 performs the encryption process for the contents information is reduced according to the control performed by the outputting/controlling unit 58. Since also the number of repetition times that the decryption required to output the contents information is reduced in this case, the processing time required to decrypt the contents information is decreased. Consequently, also the troublesomeness that the contents user feels is alleviated. Accordingly, the contents user will actively issue an instruction to output the advertisement information so as to alleviate his or her feeling of troublesomeness. Namely, with this configuration, motivation to actively output advertisement information can be given to a contents user.

Also with a contents distributing method implemented by the contents distributing device 10 shown in FIG. 1 or the contents distributing device 40 shown in FIG. 2, or with a contents distributing program for causing a computer to execute the process performed by either of these devices, and with a contents outputting method implemented by the contents outputting device 20 shown in FIG. 1 or the contents outputting device 50 shown in FIG. 2, or with a contents outputting program for causing a computer to execute the process performed by either of these devices, a similar operation effect can be obtained, and the above described problem is overcome.

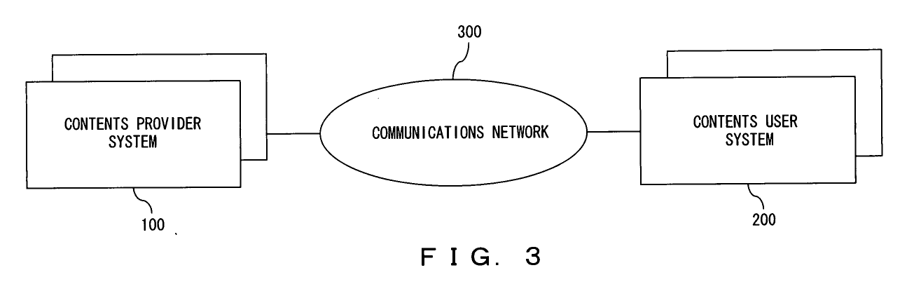

FIG. 3 is described next. This figure shows the entire configuration of a system implementing the present invention. The system shown in this figure is configured by connecting, to a communications network 300 such as the Internet, a contents provider system 100 used by a contents provider that distributes contents, and a contents user system 200 used by a contents user who receives the distribution of the contents and views the contents. The contents provider system 100 and the contents user system 200 can mutually transmit/receive various types of data via the communications network 300.

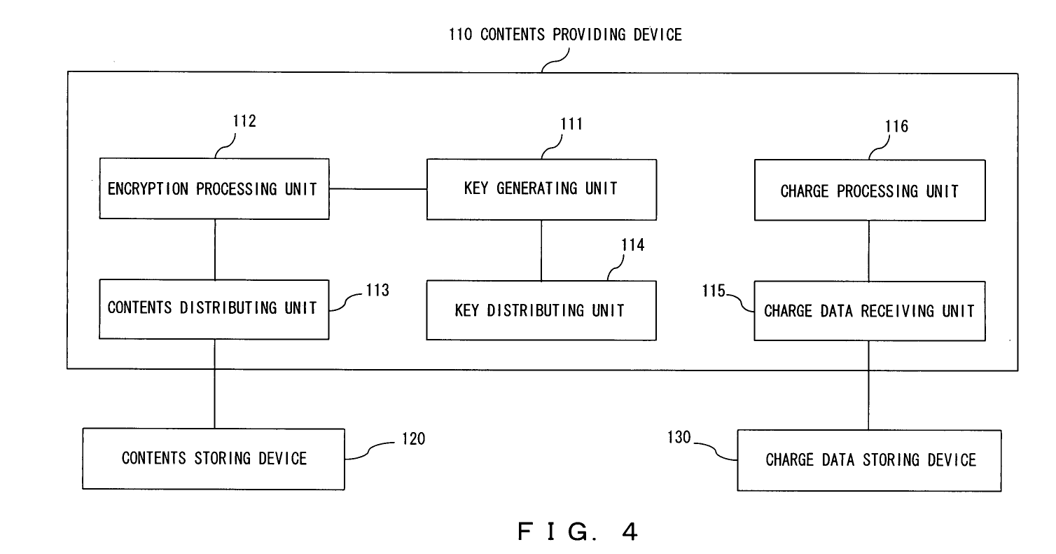

The contents provider system 100 is described. Configuration of the contents provider system 100 is shown in FIG. 4. As shown in this figure, the contents provider system 100 is configured by a contents providing device 110, a contents storing device 120, and a charge data storing device 130.

Capabilities and configuration of the contents providing device 110 are described below.

A key generating unit 111 generates a pair of keys composed of encryption key data (hereinafter referred to simply as an encryption key) used to encrypt data, and decryption key data (hereinafter referred to simply as a decryption key) required to decrypt the data encrypted with the encryption key. For the generation of the pair of keys made by the key generating unit 111, for example, a technique for generating a pair of public and secret keys used in a public key encryption method, which is a known technique, may be available unchanged.

An encryption processing unit 112 encrypts contents data which represents contents (hereinafter referred to simply as contents), and advertisement data which represents an advertisement (hereinafter referred to simply as an advertisement) with the encryption key generated by the key generating unit 111. The encrypted contents and advertisement are passed to a contents distributing unit 113, and stored in the contents storing device 120.

The contents distributing unit 113 detects whether or not data indicating a distribution request for contents, which is transmitted from the contents user system 200, is received. If the contents distributing unit 113 detects that this data is received, it reads the encrypted contents and advertisement, which are stored in the contents storing device 120, and transmits the read contents and advertisement, which are addressed to the contents user system 200, to the communications network 300.

A key distributing unit 114 detects whether or not data indicating a distribution request for a decryption key, which is transmitted from the contents user system 200, is received. If the key distributing unit 114 detects that this data is received, it obtains the decryption key which enables the encrypted contents and advertisement, which are stored in the contents user system 200, to be decrypted, makes the key generating unit 111 generate another pair of encryption and decryption keys different from the above described decryption key, obtains the generated encryption key out of the newly generated pair from the key generating unit 111, and transmits the obtained decryption and encryption keys, which are addressed to the contents user system 200, to the communications network 300.

A charge data receiving unit 115 receives advertisement/contents view times data, which is periodically transmitted from the contents user system 200, and stores the received advertisement/contents view times data in the charge data storing device 130.

A charge processing unit 116 reads the advertisement/contents view times data stored in the charge data storing device 130, and generates charge data indicating a charge in exchange for viewing the contents, which is made to the contents user who views the contents with the contents user system 200, in response to a request to perform a charge process, which is issued by a contents provider.

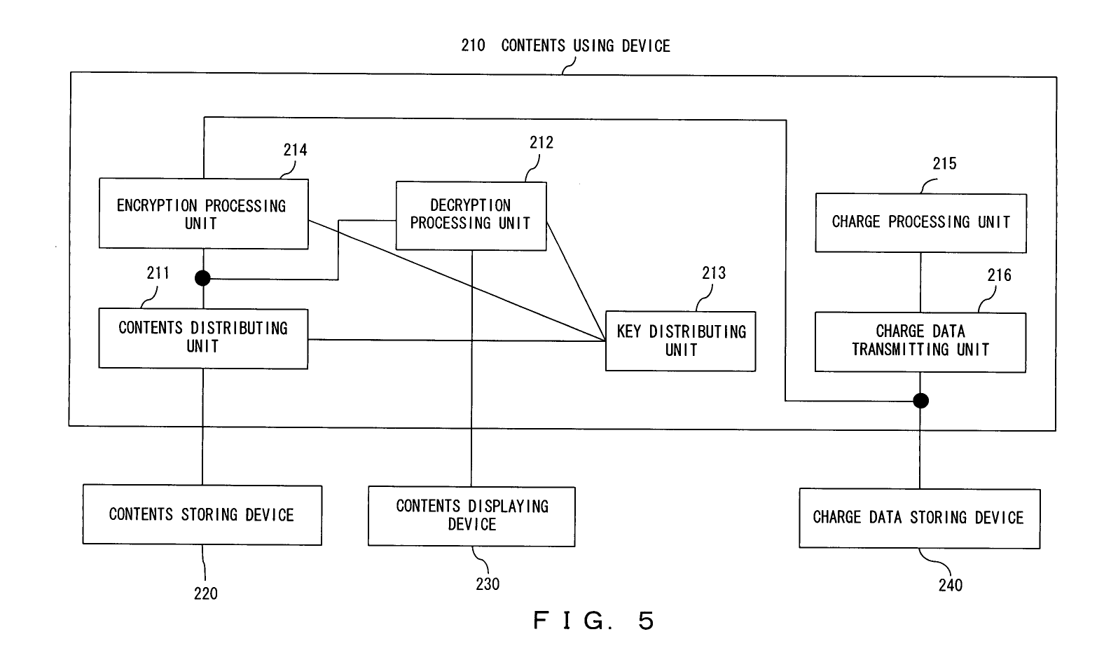

The contents user system 200 is described next. Configuration of the contents user system 200 is shown in FIG. 5. As shown in this figure, the contents user system 200 is configured by a contents using device 210, a contents storing device 220, a contents displaying device 230, and a charge data storing device 240.

Capabilities and configuration of the contents using device 210 are described below.

When an input corresponding to a contents user instruction which indicates a distribution request for contents is obtained, a contents distributing unit 211 transmits, to the communications network 300, data indicating the distribution request for the contents, which is addressed to the contents provider system 100. Additionally, the contents distributing unit 211 receives the encrypted contents and advertisement, which are transmitted from the contents provider system 100 in response to this data, and stores the received data in the contents storing device 220.

When an input corresponding to a contents user instruction which indicates a view request for the contents stored in the contents storing device 220 is obtained, a decryption processing unit 212 first issues a distribution request for a decryption key to a key distributing unit 213.

The key distributing unit 213 transmits, to the communications network 300, data indicating the distribution request for the key, which is addressed to the contents provider system 100, in response to the distribution request for the decryption key, which is issued from the decryption processing unit 212. Additionally, the key distributing unit 213 receives the decryption key which enables the encrypted contents and advertisement, which are transmitted from the contents provider system 100, to be decrypted in response to this data, and an encryption key, which does not pair with this decryption key and is one out of a pair of keys newly generated by the key generating unit 111, and transmits the decryption key out of the received two keys to the decryption processing unit 212.

The decryption processing unit 212 reads information indicating the number of times that the same contents is decrypted, which is stored in the charge data storing device 240, receives the encrypted contents and advertisement, which are stored in the contents storing device 220, from the contents distributing unit 211, and performs a decryption process for the encrypted contents and advertisement with the decryption key received from the key distributing unit 213. Note that the decryption processing unit 212 performs the decryption process by the number of times that is larger than the number of decryption times, which is read from the charge data storing device 240, by 1 for the encrypted contents and advertisement.

Then, the decryption processing unit 212 provides the contents to the contents user by displaying the decrypted contents on the contents displaying device 230. At the same time, the decryption processing unit 212 increments (by 1) the number of decryption times obtained from the information stored in the charge data storing device 240, and again stores the information indicating the number of decryption times after being incremented. Here, if an input corresponding to a contents user instruction indicating a view request for the advertisement is obtained, the decrypted advertisement is displayed on the contents displaying device 230, and presented to the contents user. At the same time, the number of decryption times is reset to 0, and the information indicating the number of decryption times after being reset is again stored in the charge data storing device 240.

When an input corresponding to a contents user instruction indicating the termination of viewing the contents is obtained, an encryption processing unit 214 reads information indicating the number of decryption times of the same contents, which is stored in the charge data storing device 240. At the same time, the encryption processing unit 214 receives the encryption key received by the key distributing unit 213, repeatedly performs an encryption process by the number of times that is larger than the number of decryption times by 1 for the contents and the advertisement, which are decrypted by the decryption processing unit 212, and passes the encrypted contents and advertisement to the contents distributing unit 211, which makes the contents storing device 220 store the encrypted contents and advertisement.

Each time the contents and the advertisement are displayed on the contents displaying device 230, a charge processing unit 215 counts the respective numbers of times that the contents and the advertisement are displayed, stores the numbers of times in the charge data storing device 240 as advertisement/contents view times data, and periodically reads the advertisement/contents view times data from the charge data storing device 240.

Each time the charge processing unit 215 reads the advertisement/contents view times data from the charge data storing device 240, a charge data transmitting unit 216 transmits the read data, which is addressed to the contents provider system 100, to the communications network 300.

The system that is shown in FIG. 3 and implements the present invention is configured as described above.

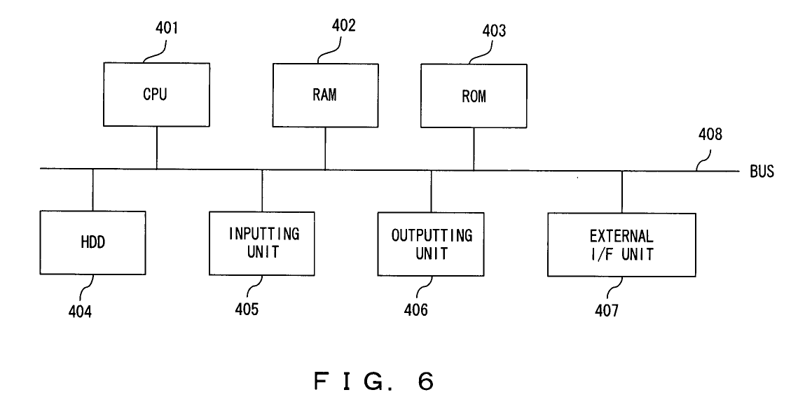

The contents provider system 100 shown in FIG. 4, and the contents user system shown in FIG. 5 can be implemented by executing a control program on a computer system having a standard hardware configuration shown in FIG. 6.

FIG. 6 is described below.

The computer system shown in this figure is configured by interconnecting a CPU 401, a RAM 402, a ROM 403, an HDD 404, an inputting unit 405, an outputting unit 406, and an external interface unit 407 via a bus 408. These constituent elements can mutually transmit/receive data under the control of the CPU 401.

The CPU (Central Processing Unit) 401 is a central processing unit which governs the operation control of the whole of this computer system.

The RAM (Random Access Memory) 402 is used as a working memory when the CPU 401 executes various types of control programs, and also used as a main memory in which temporary storage space is used for various types of data depending on need.

The ROM (Read-Only Memory) 403 is a memory which prestores a fundamental control program executed by the CPU 401. The CPU 401 executes this fundamental control program when this computer system is started up, so that the fundamental control for the operations of the entire computer system is performed by the CPU 401.

The HDD (Hard Disk Drive) 404 is used as the contents storing device 120 and the charge data storing device 130 if this computer system functions as the contents provider system 100. In the meantime, if this computer system functions as the contents user system 200, the HDD 404 is used as the contents storing device 220 and the charge data storing device 240. The HDD 404 also stores a control program for causing this computer system to execute a process performed by the contents provider system 100 among processes to be described later if this computer system functions as the contents provider system 100. If this computer system functions as the contents user system 200, the HDD 404 stores a control program for causing this computer system to execute a process performed by the contents user system 200 among the processes to be described later. The CPU 401 reads and executes these control programs after executing the above described fundamental control program.

The inputting unit 405 receives an external input, and passes the content of the input to the CPU 401. The inputting unit 405 is configured by comprising an inputting device such as a keyboard, a mouse, etc., which receives an instruction from an operator (a contents provider or a contents user in this preferred embodiment) that operates this computer system, or by comprising a reading device for a portable storage medium such as an FD (Flexible Disk), a CD-ROM (Compact Disc-ROM), a DVD-ROM (Digital Versatile Disc-ROM), an MO (Magneto-Optic) disk, etc., depending on need.

The outputting unit 406 makes an output according to an instruction from the CPU 401. The outputting unit 406 is, for example, a display device configured by comprising a CRT (Cathode Ray Tube) or an LCD (Liquid Crystal Display), which displays various types of data, a printer device printing and displaying various types of data, or the like.

The external I/F (interface) unit 407 manages a communication, which is made when this computer system is connected to the communications network 300, and data is transmitted/received to/from another system connected to the communications network 300.

The computer system shown in FIG. 6 is configured by comprising the above described constituent elements.

Processes respectively performed by the contents provider system 100 and the contents user system 200 in the system shown in FIG. 3 are described next.

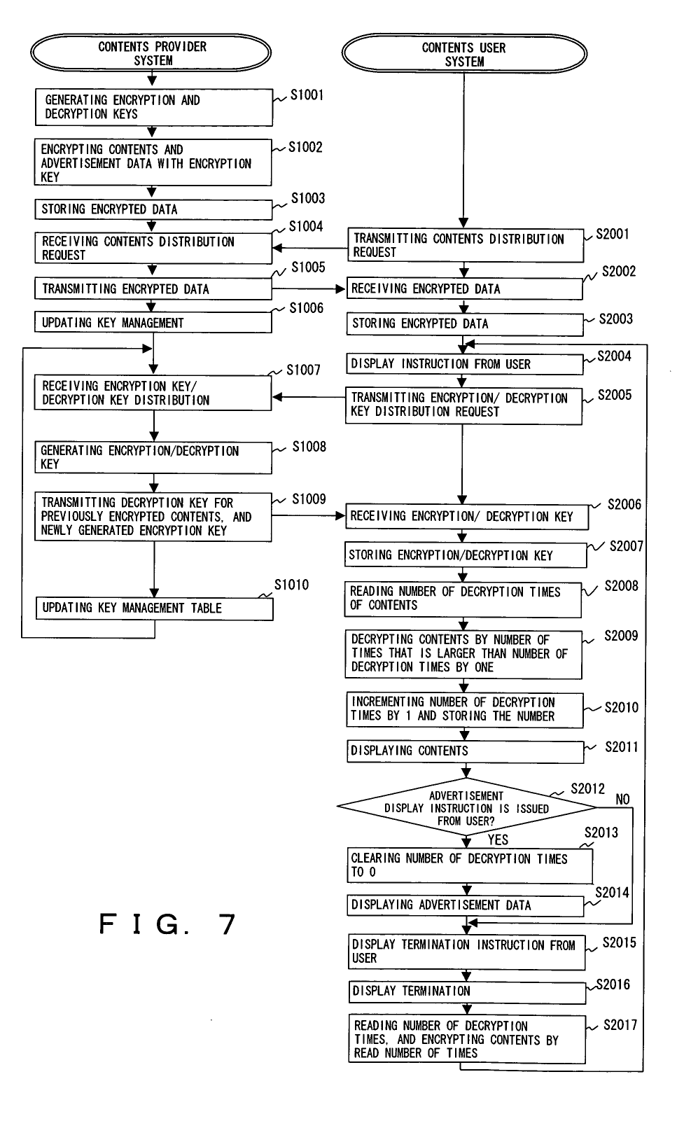

FIG. 7 is first described. This figure shows the details of a contents distribution/provision process performed by the contents provider system 100 and the contents user system 200.

Processes in steps S1001 to S1008, which are shown on the left side flow in this figure, represent the processes performed by the contents provider system 100, whereas processes in S2001 to S2015, which are shown on the right side flow in this figure, represent the processes performed by the contents user system 200.

To make these systems execute the process shown in FIG. 7 in the case where both of the contents provider system 100 and the contents user system 200 are built by the computer system having the standard hardware configuration shown in FIG. 6, a control program for causing the computer system shown in FIG. 6 to execute the process performed by each of the systems in FIG. 7 may be generated and prestored onto the HDD 404 of each of the systems, and the CPU 401 may be made to read and execute this control program.

In FIG. 7, the processes in steps S1001 to S1003 are first performed by the contents provider system 100. Namely, encryption and decryption keys, which are a pair of keys, are generated by the key generating unit 111 in S1001. Next, in S1002, an encryption process using the encryption key out of the pair of keys generated in the process in S1001 is performed for contents and an advertisement, which are stored in the contents storing device 120, by the encryption processing unit 112. Then, in S1003, the encrypted contents and advertisement are stored in the contents storing device 120 by the contents distributing unit 113.

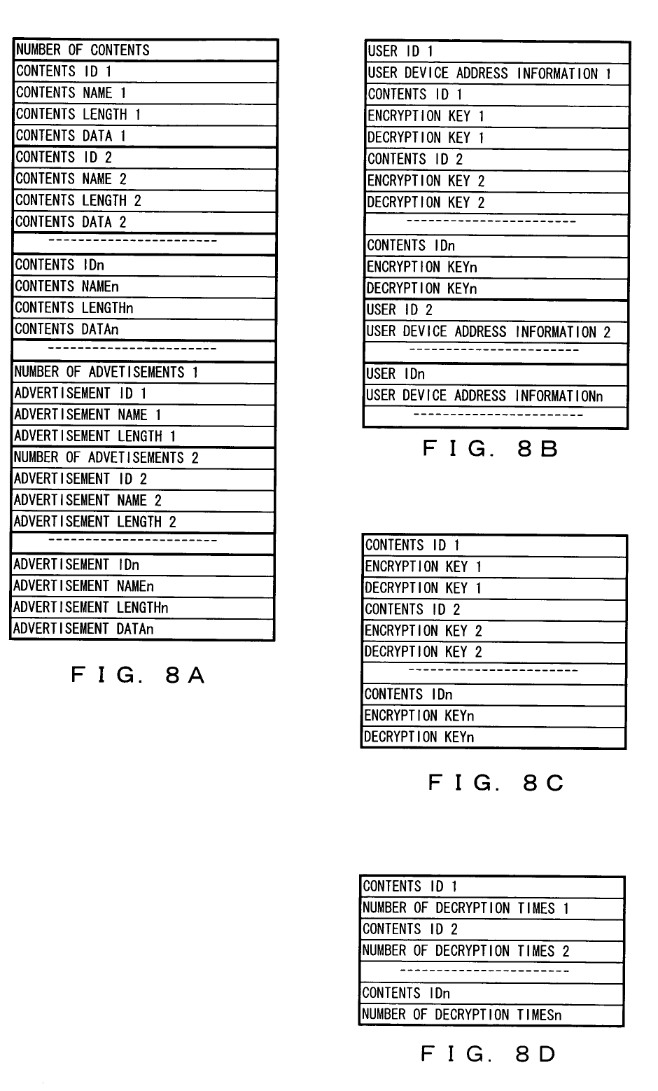

Here, FIGS. 8A, 8B, 8C, and 8D are described. These figures show the data structures of various types of tables used in the system shown in FIG. 3.

FIG. 8A shows the data structure of a storage file for contents/advertisement data stored in the contents storing device 120. As shown in this figure, this file stores, as contents data, the number of stored contents, and for each contents, contents ID (IDentification) data, which is assigned to each contents so as to identify the contents distributed to a contents user, contents length data indicating the data size of contents, and the entity of contents data. This file also stores, as data of an advertisement corresponding to each contents, the number of stored advertisements, and for each advertisement, advertisement ID data assigned to each advertisement so as to identify an advertisement distributed to an advertisement user, advertisement length data indicating the data size of an advertisement, and the entity of advertisement data.

The storage file shown in FIG. 8A for contents and an advertisement, which are not encrypted, is prestored in the contents storing device 120. Furthermore, a storage file for encrypted contents and advertisement, which has a data structure similar to that shown in FIG. 8A, is generated for each contents user, and stored in the contents storing device 120 with the above described process in S1003.

Turning back to the description of FIG. 7.

If an input corresponding to a contents user instruction indicating a distribution request for contents is obtained in the contents user system 200, the contents distributing unit 211 transmits, to the communications network 300, data which indicates the distribution request for the contents and is addressed to the contents provider system 100 in S2001.

In the meantime, a process in S1004 is performed by the contents provider system 100. Namely, a reception process for the data indicating the distribution request for the contents is performed by the contents distributing unit 113.

When the reception of the data indicating the distribution request for the contents is detected with the process in S1004, the encrypted contents stored in the contents storing device 120, and the encrypted advertisement, which corresponds to the contents, for the contents user being the transmission source of the received distribution request are read by the contents distributing unit 113, addressed to the contents user system 200, and transmitted to the communications network 300 in S1005.

Then, in S1006, a process for updating a contents provider side encryption key/decryption key management table stored in the contents storing device 120 is performed by the contents distributing unit 113.

Here, FIG. 8B is described. This figure shows the data structure of the contents provider side encryption key/decryption key management table stored in the contents storing device 120. As shown in this figure, user ID data assigned to identify a contents user, and user device address information, which is data for identifying the contents user system 200 used by the contents user, are corresponded and managed by this table for each contents user using the contents user system 200. Furthermore, an encryption key used to encrypt the contents distributed to this contents user, and a decryption key used to decrypt the contents encrypted with this encryption key are managed for each contents user in correspondence with contents ID data assigned to each contents so as to identify the contents distributed to a contents user.

With a process in S1006, a decryption key required to decrypt the encrypted contents and advertisement, which are transmitted with the process in S1005, and the encryption key used to encrypt the contents and the advertisement are stored in the contents provider side encryption key/decryption key management table for each contents user in correspondence with the contents ID assigned to the transmitted contents.

In the meantime, a process in S2002 is performed by the contents user system 200. Namely, a reception process for the encrypted contents and advertisement, which are transmitted from the contents provider system 100 with the above described process in S1005, is performed by the contents distributing unit 211.

When the encrypted contents and advertisement are received with the process in S2002, the received contents and advertisement are stored in the contents storing device 220 by the contents distributing unit 211 in S2003. In the contents storing device 220, a storage file having a data structure similar to that shown in FIG. 8A is generated, and the encrypted contents and advertisement are stored in the storage file.

In S2004, a process for obtaining an input corresponding to a contents user instruction which indicates a request to display any of the contents stored in the contents storing device 220 on the contents displaying device 230 is performed. When this input is obtained, data which indicates a distribution request for a decryption key required to decrypt the contents instructed as the display target in the decryption processing unit 212 is addressed to the contents provider system 100, and transmitted to the communications network 300 by the key distributing unit 213 in S2005.

In the meantime, a process in S1007 is performed in the contents provider system 100, and a reception process for the data which indicates the distribution request for the decryption key is performed by the key distributing unit 114.

When the data which indicates the distribution request for the decryption key is received with the process in S1007, another pair of encryption and decryption keys different from the decryption key for this distribution request is generated by the key generating unit 111 in S1008.

In S1009, the decryption key for the distribution request, which is received with the process in S1007, is read from the contents storing device 120, and this decryption key, and the encryption key out of the pair of keys generated with the process in S1008 are addressed to the contents user system 200, and transmitted to the communications network 300 by the key distributing unit 114.

In S1010, a process for updating the contents provider side encryption key/decryption key management table stored in the contents storing device 120 is performed by the contents distributing unit 113. With this process, the decryption key and the encryption key, which are corresponded to the contents for the distribution request received with the process in S1007, are overwritten with the pair of encryption and decryption keys generated with the process in S1008.

Upon termination of the process in S1010, the process performed by the contents provider system 100 goes back to S1007, and the above described processes are repeated.

In the meantime, a process in S2006 is performed in the contents user system 200. Namely, a reception process for the decryption and the encryption keys, which are transmitted from the contents user system 200 with the process in S1009, is performed by the key distributing unit 213.

In S2007, a process for updating the contents user side encryption key/decryption key management table stored in the contents storing device 220, and for storing the decryption and the encryption keys, which are received with the process in S2006, is performed by the contents distributing unit 211.

Here, FIG. 8C is described. This figure shows the data structure of the contents user side encryption key/decryption key management table stored in the contents storing device 220. As shown in this figure, contents ID data assigned to each contents so as to identify contents, a decryption key used to decrypt encrypted contents, and an encryption key received along with this decryption key with the process in S1009 are corresponded and managed by this table for each encrypted contents stored in the contents storing device 220.

With the process in S2007, the decryption key and the encryption key, which are corresponded to the contents ID data, are overwritten.

In S2008, information indicating the number of decryption times of the contents, which is stored in the charge data storing device 240, for the display request obtained with the process in S2004 is read by the decryption processing unit 212.

Here, FIG. 8D is described. This figure shows the data structure of the contents user side decryption times management table stored in the charge data storing device 240. As shown in this figure, contents ID data assigned to each contents so as to identify contents, and information indicating the number of times that the decryption process is performed for the contents are corresponded and managed by this table for each encrypted contents stored in the contents storing device 220.

In S2009, the contents and the advertisement, which correspond to the display request obtained with the process in S2004, among the encrypted contents and advertisements stored in the contents storing device 220 are read, and the decryption process for the encrypted contents and advertisement is performed with the decryption key obtained with the process in S2006. In the decryption processing unit 212, the decryption process is performed for the encrypted contents and advertisement by the number of times that is larger than the number of decryption times, which is obtained from the charge data storing device 240 with the process in S2008, by 1.

In S2010, a process for incrementing (by 1) the number of decryption times, which is obtained from the information stored in the contents user side decryption times management table of the charge data storing device 240, and for storing information indicating the number of times resultant from the increment in a storage position for the corresponding contents in the contents user side decryption times management table is performed by the charge processing unit 215.

In S2011, a process for displaying the contents decrypted with the most recent decryption process in S2009 on the contents displaying device 230 is performed by the decryption processing unit 212.

In S2012, a process for determining whether or not an input corresponding to a contents user instruction which indicates a display request for the advertisement corresponding to the contents displayed with the process in S2011 is performed by the decryption processing unit 212. If a result of this determination process is “Yes”, namely, if the input corresponding to the instruction which indicates the display request for the advertisement is obtained, the process proceeds to S2013. If the result of this determination process is “No”, namely, if the input corresponding to the instruction which indicates the display request for the advertisement is not obtained, the process goes to step S2015.

In S2013, a process for clearing to 0 the information indicating the number of decryption times, which is stored in the contents user side decryption times management table of the charge data storing device 240 with the process in S2010, is performed by the decryption processing unit 212. Then, in S2014, a process for displaying the advertisement, which is decrypted with the most recent decryption process in S2009, on the contents displaying device 230 is performed by the decryption processing unit 212.

In S2015, a process for obtaining an input corresponding to a contents user instruction which indicates a request to terminate the display on the contents displaying device 230 is performed by the decryption processing unit 212. When this input is obtained, a process for stopping the current display on the contents displaying device 230 is performed by the decryption processing unit 212 in S2016.

In S2017, a process for reading the information indicating the number of times of the same contents, which is stored in the charge data storing device 240, for also reading the decryption key, which is stored in the contents user side encryption key/decryption key management table of the contents storing device 220 with the most recent key storage process in S2007, for repeatedly performing the encryption process by the number of times that is larger than the number of decryption times by 1 for the contents and the advertisement, which are decrypted by the decryption processing unit 212, and for passing the encrypted contents and advertisement to the contents distributing unit 211, which stores the encrypted contents and advertisement in the contents storing device 220, is performed by the encryption processing unit 214. When the encrypted contents and advertisement are stored in the contents storing device 220, the contents and the advertisement, which are stored in the contents storing device 220 until at that time and decrypted with the process in S2009, are overwritten.

After the process in S2017 is terminated, the process by the contents user system 200 goes back to S2003, and the above described processes are repeated.

The process described up to this point is the contents distribution/provision process. This process is performed by the contents provider system 100 and the contents user system 200, so that a contents user must obtain a decryption key and a new encryption key from the contents provider system 100 each time he or she views the same contents without viewing an advertisement, and must perform a decryption process for encrypted contents by the number of times according to the number of view times until at that time. As a result, the time required to enable contents to be viewed becomes longer with the repetition of viewing the same contents. Therefore, a contents user will view an advertisement to free from such troublesomeness. As contents whose same portion is frequently repeated, for example, game software can be cited.

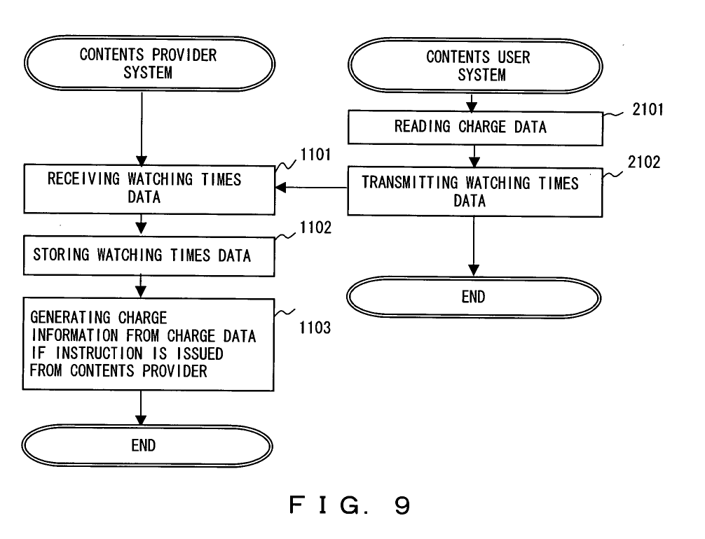

FIG. 9 is described next. This figure shows the details of a charge information generation process performed by the contents provider system 100 and the contents user system 200. This process is a process for periodically generating information, which indicates a charge made to a contents user in exchange for the use of contents, based on the number of times that contents and an advertisement are viewed with the contents user system 200, in the contents provider system 100.

Processes in S1101 to S1103, which are shown in the left side flow of FIG. 9, indicate processes performed by the contents provider system 100, whereas processes in S2101 and S2102, which are shown in the right side row of this figure, indicate processes performed by the contents user system 200.

To make the contents provider system 100 and the contents user system 200 perform the process shown in FIG. 9 when both of these systems are configured as shown in FIG. 6, a control program for causing the computer system shown in FIG. 6 to execute the process for each of the systems shown in FIG. 9 may be generated and prestored onto the HDD 404 of each of the systems, and the CPU 401 may be made to read and execute this control program.

In FIG. 9, the above described process for reading the information indicating the number of decryption times from the charge data storing device 240 periodically, for example, once a month is performed by the charge processing unit 215 of the contents user system 200.

In S2102, data that is read with the process in S2101 and indicated by the contents user side decryption times management table is addressed to the contents provider system 100 and transmitted to the communications network 300 by the charge data transmitting unit 216. After this process is terminated, the process by the contents user system 200 is terminated.

In the meantime, the process in S1101 is performed by the contents provider system 100. Namely, a reception process for the data indicated by the contents user side decryption times management table is performed by the charge data receiving unit 115. This received data is stored by the charge data receiving unit 115 in the charge data storing device 150.

In S1103, a process for obtaining an input corresponding to a contents provider instruction which indicates a request to calculate a charge to the contents user is performed. When this input is obtained, a process for calculating the charge to the contents user based on the information stored in the charge data storing device 150 is performed by the charge processing unit 116, and information indicating the amount of this charge is generated and output. After this process is terminated, the process by the contents provider system 100 is terminated.

The process up to this point is the contents distribution/provision process. This process is performed by the contents provider system 100 and the contents user system 200, whereby information which indicates a charge made to a contents user in exchange for the use of contents is periodically generated.

A control program for causing a computer to execute the above described contents distribution/provision process and charge information generation process may be recorded on a computer-readable storage medium, and the computer may be made to read and execute the program from the storage medium, so that the present invention can be also implemented.

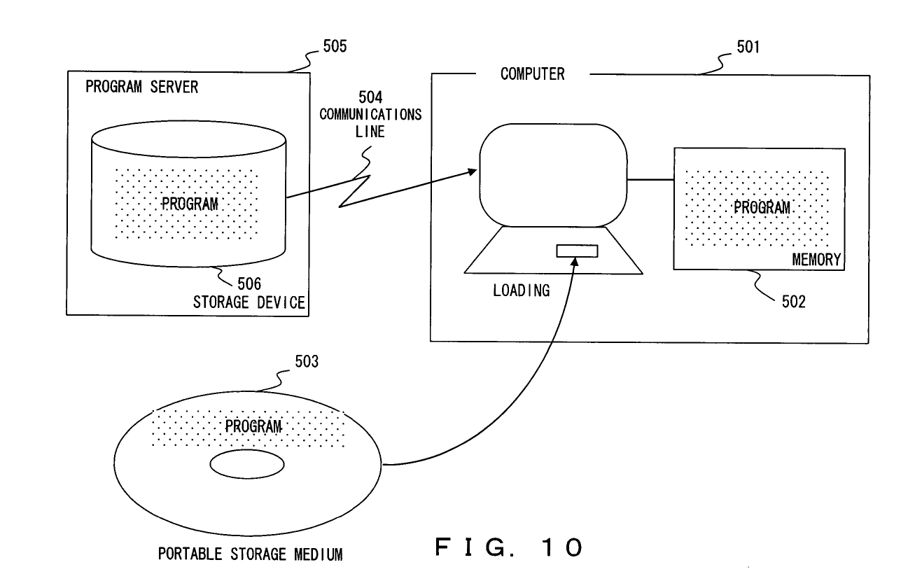

Examples of the computer-readable storage medium on which the control program is recorded are shown in FIG. 10. As shown in this figure, for example, a memory 502 such as a RAM, a ROM, a hard disk device, etc., which is included in a computer 501 or externally attached to the computer 501, or a portable storage medium 503 such as a flexible disk, an MO (Magneto-Optical) disk, a CD-ROM, a DVD-ROM, etc., is available as the storage medium. Or, the storage medium may be a storage device 506 comprised by a computer which is connected to the computer 501 via a communications line 504, and functions as a program server 505. In this case, a transmission signal obtained by modulating a carrier wave with a data signal which represents the control program is transmitted from the program server 505 via the communications line 504 being a transmission medium, and the computer 501 regenerates the control program by demodulating the received transmission signal, so that the control program can be executed.

The present invention is not limited to the above described preferred embodiment, and various improvements and modifications can be made. For example, in the process for calculating a charge, which is performed by the charge processing unit 116, a charge made to a contents user may be discounted according to the number of times that the contents user views an advertisement.

As described above in detail, according to the present invention, an effect that a repetitive output of contents can be suppressed in contents information distribution using a communications network, and that a motivation to actively output an advertisement distributed along with contents can be given to a contents user is obtained.

What is claimed is:

1. A contents distributing method, comprising:
transmitting, to a communications network, contents information which represents contents and is encrypted with an encryption key;
transmitting, to the communications network, an encryption key used to perform an encryption process, which cannot be decrypted with a decryption key, for the contents information along with the decryption key requested by a distribution request in response to the distribution request for the decryption key required to decrypt the encrypted contents information; and
transmitting, to the communications network, an encryption key used to perform an encryption process, which cannot be decrypted with a decryption key, for the contents information along with the decryption key requested by a distribution request, each time information indicating the distribution request for the decryption key required to decrypt the contents information, for which the encryption process is performed with the encryption key transmitted to the communications network, is received, wherein
an encryption process using the encryption key, which is received from the communications network along with the decryption key, is again performed for the contents information transmitted to the communications network, and the contents information is stored in a reception terminal, after the contents information is decrypted with the decryption key received from the communications network, and output in the reception terminal which receives the contents information.

2. A contents outputting method, comprising:
receiving, from a communications network, contents information which represents contents and is encrypted with an encryption key;
storing the received encrypted contents information;
transmitting, to the communications network, distribution request information indicating a distribution request for a decryption key required to decrypt the contents information, each time a request to output the stored contents information is input;
receiving, from the communications network, the decryption key which is requested by the distribution request information and transmitted in response to the distribution request information, and an encryption key used to perform an encryption process, which cannot be decrypted with the decryption key, for the contents information;
decrypting the encrypted contents information with the decryption key transmitted in response to the distribution request information, and outputting the contents information;
performing an encryption process for the contents information with the encryption key, which is received along with the decryption key transmitted in response to the distribution request information, after the contents information is output; and
again storing the contents information for which the encryption process is performed.

3. The contents outputting method according to claim 2, further comprising:
repeatedly performing an encryption process with the same encryption key by a number of times, which corresponds to a number of repetition times that the contents information is output, when the encryption process is performed for the contents information, if an output of the contents information is repeated; and
repeatedly performing decryption by a number of times, which corresponds to a number of repetition times of the encryption process, for the contents information with the same decryption key, if the contents information for which the encryption process is repeatedly performed is output.

4. The contents outputting method according to claim 3, further comprising:
receiving, from the communications network, also advertisement information which is corresponded to the contents information and represents an advertisement, when the encrypted contents information is received from the communications network; and
outputting the advertisement information, and reducing the number of repetition times when the encryption process is repeatedly performed for the contents information, when an instruction to allow the advertisement information to be output is input.

5. The contents distributing method according to claim 1, further comprising:
transmitting, to the communications network, also advertisement information which is corresponded to the contents information and represents an advertisement, when the encrypted contents information is transmitted to the communications network;
repeatedly performing an encryption process by a number of times, which corresponds to a number of repetition times that the contents information is output, with the same encryption key when the encryption process is performed for the contents information, if an output of the contents information is repeated in the reception terminal;
repeatedly performing the decryption by a number of times, which corresponds to a number of repetition times of the encryption process, with the same decryption key in the reception terminal when the contents information for which the encryption process is repeatedly performed is output in the reception terminal; and
outputting the advertisement information, and reducing the number of repetition times when the encryption process is repeatedly performed for the contents information, when an instruction to allow the advertisement information to be output is input, in the reception terminal.

6. A contents distributing method, comprising:
transmitting, to a communications network, contents information and advertisement information which respectively represent contents and an advertisement, and are encrypted with an encryption key; and
transmitting, to the communications network, an encryption key used to perform an encryption process, which cannot be decrypted with a decryption key, for the contents information and the advertisement information along with the decryption key requested by a distribution request in response to the distribution request for the decryption key required to decrypt the encrypted contents information and advertisement information, wherein
an encryption process using the encryption key, which is received from the communications network along with the decryption key, is repeatedly performed by a number of times, which corresponds to a number of repetition times that the contents information is output, for the contents information and the advertisement information, which are transmitted to the communications network, and the encrypted contents information and advertisement information are stored, after the contents information and the advertisement information are decrypted with the decryption key received from the communications network, and the contents information is output in a reception terminal which receives the contents information and the advertisement information, and
in the reception terminal, the advertisement information is output, and the number of repetition times when the encryption process is repeatedly performed for the contents information is reduced, when an instruction to allow the advertisement information to be output is input.

7. A contents outputting method, comprising:
receiving, from a communications network, contents information and advertisement information which respectively represent contents and an advertisement, and are encrypted with an encryption key;
storing the received encrypted contents information and advertisement information;
transmitting, to the communications network, distribution request information indicating a distribution request for a decryption key required to decrypt the stored contents information and advertisement information;
receiving, from the communications network, the decryption key which is requested by the distribution request information and transmitted in response to the distribution request information, and an encryption key used to perform an encryption process, which cannot be decrypted with the decryption key, for the contents information;
decrypting the encrypted contents information with the decryption key transmitted in response to the distribution request information, and outputting the contents information;
repeatedly performing an encryption process with the encryption key, which is received along with the decryption key, for the contents information by a number of times, which corresponds to a number of repetition times that the contents information is output, after the contents information is output; and
again storing the contents information for which the encryption process is performed, wherein
the advertisement information is output, and the number of repetition times that the encryption process is performed for the contents information is reduced, when an instruction to allow the advertisement information to be output is input.

8. A computer-readable storage medium on which is recorded a contents distributing program for causing a computer to execute a process, the process comprising:
transmitting, to a communications network, contents information which represents contents and is encrypted with an encryption key;
transmitting, to the communications network, an encryption key used to perform an encryption process, which cannot be decrypted with a decryption key, for the contents information along with the decryption key requested by a distribution request in response to the distribution request for the decryption key required to decrypt the encrypted contents information; and
transmitting, to the communications network, an encryption key used to perform an encryption process, which cannot be decrypted with a decryption key, for the contents information along with the decryption key requested by a distribution request, each time information indicating the distribution request for the decryption key required to decrypt the contents information, for which the encryption process is performed with the encryption key transmitted to the communications network, is received, wherein
an encryption process using the encryption key, which is received from the communications network along with the decryption key, is again performed for the contents information transmitted to the communications network, and the contents information is stored in a reception terminal, after the contents information is decrypted with the decryption key received from the communications network, and output in the reception terminal which receives the contents information.

9. A computer-readable storage medium on which is recorded a contents outputting program for causing a computer to execute a process, the process comprising:
receiving, from a communications network, contents information which represents contents and is encrypted with an encryption key;
storing the received encrypted contents information;
transmitting, to the communications network, distribution request information indicating a distribution request for a decryption key required to decrypt the contents information, each time a request to output the stored contents information is input;
receiving, from the communications network, the decryption key which is requested by the distribution request information and transmitted in response to the distribution request information, and an encryption key used to perform an encryption process, which cannot be decrypted with the decryption key, for the contents information;
decrypting the encrypted contents information with the decryption key transmitted in response to the distribution request information, and outputting the contents information;
performing an encryption process for the contents information with the encryption key, which is received along with the decryption key transmitted in response to the distribution request information, after the contents information is output; and
again storing the contents information for which the encryption process is performed.

10. A computer-readable storage medium on which is recorded a contents distributing program for causing a computer to execute a process, the process comprising:
transmitting, to a communications network, contents information and advertisement information which respectively represent contents and an advertisement, and are encrypted with an encryption key; and
transmitting, to the communications network, an encryption key used to perform an encryption process, which cannot be decrypted with a decryption key, for the contents information and the advertisement information along with the decryption key requested by a distribution request in response to the distribution request for the decryption key required to decrypt the encrypted contents information and advertisement information, wherein
an encryption process using the encryption key, which is received from the communications network along with the decryption key, is repeatedly performed by a number of times, which corresponds to a number of repetition times that the contents information is output, for the contents information and the advertisement information, which are transmitted to the communications network, and the encrypted contents information and advertisement information are stored, after the contents information and the advertisement information are decrypted with the decryption key received from the communications network, and the contents information is output in a reception terminal which receives the contents information and the advertisement information, and
in the reception terminal, the advertisement information is output, and the number of repetition times when the encryption process is repeatedly performed for the contents information is reduced, when an instruction to allow the advertisement information to be output is input.

11. A computer-readable storage medium on which is recorded a contents outputting program for causing a computer to execute a process, the process comprising:
receiving, from a communications network, contents information and advertisement information which respectively represent contents and an advertisement, and are encrypted with an encryption key;
storing the received encrypted contents information and advertisement information;
transmitting, to the communications network, distribution request information indicating a distribution request for a decryption key required to decrypt the stored contents information and advertisement information;
receiving, from the communications network, the decryption key which is requested by the distribution request information and transmitted in response to the distribution request information, and an encryption key used to perform an encryption process, which cannot be decrypted with the decryption key, for the contents information;
decrypting the encrypted contents information with the decryption key transmitted in response to the distribution request information, and outputting the contents information;
repeatedly performing an encryption process using the encryption key, which is received along with the decryption key, for the contents information by a number of times, which corresponds to a number of repetition times that the contents information is output, after the contents information is output; and
again storing the contents information for which the encryption process is performed, wherein
the advertisement information is output, and the number of repetition times that the encryption process is performed for the contents information is reduced, when an instruction to allow the advertisement information to be output is input.

12. A contents distributing device, comprising:
a contents information transmitting unit transmitting, to a communications network, contents information which represents contents and is encrypted with an encryption key;
a first key transmitting unit transmitting, to the communications network, an encryption key used to perform an encryption process, which cannot be decrypted with a decryption key, for the contents information along with the decryption key requested by a distribution request in response to the distribution request for the decryption key required to decrypt the encrypted contents information; and
a second key transmitting unit transmitting, to the communications network, an encryption key used to perform an encryption process, which cannot be decrypted with the decryption key, for the contents information along with the decryption key requested by the distribution request, each time information indicating the distribution request for the decryption key required to decrypt the contents information, for which the encryption process is performed with the encryption key transmitted to the communications network, is received, wherein
an encryption process using the encryption key, which is received from the communications network along with the decryption key, is again performed for the contents information transmitted to the communications network, and the contents information is stored in a reception terminal, after the contents information is decrypted with the decryption key received from the communications network, and output in the reception terminal which receives the contents information.

13. A contents outputting device, comprising:
a contents information receiving unit receiving, from a communications network, contents information which represents contents and is encrypted with an encryption key;
a first storing unit storing the received encrypted contents information;
a key distribution request transmitting unit transmitting, to the communications network, distribution request information indicating a distribution request for a decryption key required to decrypt the contents information, each time a request to output the stored contents information is input;
a key receiving unit receiving, from the communications network, the decryption key which is requested by the distribution request information and transmitted in response to the distribution request information, and an encryption key used to perform an encryption process, which cannot be decrypted with the decryption key, for the contents information;
a contents outputting unit decrypting the encrypted contents information with the decryption key transmitted in response to the distribution request information, and outputting the contents information;
an encryption processing unit performing an encryption process for the contents information with the encryption key, which is received along with the decryption key transmitted in response to the distribution request information, after the contents information is output; and
a second storing unit again storing the contents information for which the encryption process is performed.

14. A contents distributing device, comprising:
a contents/advertisement information transmitting unit transmitting, to a communications network, contents information and advertisement information which respectively represent contents and an advertisement, and are encrypted with an encryption key; and
a key transmitting unit transmitting, to the communications network, an encryption key used to perform an encryption process, which cannot be decrypted with a decryption key, for the contents information and the advertisement information along with the decryption key requested by a distribution request in response to the distribution request for the decryption key required to decrypt the encrypted contents information and advertisement information, wherein
an encryption process using the encryption key, which is received from the communications network along with the decryption key, is repeatedly performed by a number of times, which corresponds to a number of repetition times that the contents information is output, for the contents information and the advertisement information, which are transmitted to the communications network, and the encrypted contents information and advertisement information are stored, after the contents information and the advertisement information are decrypted with the decryption key received from the communications network, and the contents information is output in a reception terminal which receives the contents information and the advertisement information, and
in the reception terminal, the advertisement information is output, and the number of repetition times when the encryption process is repeatedly performed for the contents information is reduced, when an instruction to allow the advertisement information to be output is input.

15. A contents outputting device, comprising:
a contents/advertisement information receiving unit receiving, from a communications network, contents information and advertisement information which respectively represent contents and an advertisement, and are encrypted with an encryption key;
a first storing unit storing the received encrypted contents information and advertisement information;
a key distribution request transmitting unit transmitting, to the communications network, distribution request information indicating a distribution request for a decryption key required to decrypt the stored contents information and advertisement information;
a key receiving unit receiving, from the communications network, the decryption key which is requested by the distribution request information and transmitted in response to the distribution request information, and an encryption key used to perform an encryption process, which cannot be decrypted with the decryption key, for the contents information;
a contents outputting unit decrypting the encrypted contents information with the decryption key transmitted in response to the distribution request information, and outputting the contents information;
an encryption processing unit repeatedly performing an encryption process using the encryption key, which is received along with the decryption key, for the contents information by a number of times, which corresponds to a number of repetition times that the contents information is output, after the contents information is output;
a second storing unit again storing the contents information for which the encryption process is performed; and
an outputting/controlling unit outputting the advertisement information, and reducing the number of repetition times that the encryption process is performed for the contents information, when an instruction to allow the advertisement information to be output is input.

16. A computer data signal embodied in a carrier wave and representing a contents distributing program for causing a computer to execute a process, the process comprising:
transmitting, to a communications network, contents information which represents contents and is encrypted with an encryption key;
transmitting, to the communications network, an encryption key used to perform an encryption process, which cannot be decrypted with a decryption key, for the contents information along with the decryption key requested by a distribution request in response to the distribution request for the decryption key required to decrypt the encrypted contents information; and
transmitting, to the communications network, an encryption key used to perform an encryption process, which cannot be decrypted with a decryption key, for the contents information along with the decryption key requested by a distribution request, each time information indicating the distribution request for the decryption key required to decrypt the contents information, for which the encryption process is performed with the encryption key transmitted to the communications network, is received, wherein
an encryption process using the encryption key, which is received from the communications network along with the decryption key, is again performed for the contents information transmitted to the communications network, and the contents information is stored in a reception terminal, after the contents information is decrypted with the decryption key received from the communications network, and output in the reception terminal which receives the contents information.

17. A computer data signal embodied in a carrier wave and representing a contents distributing program for causing a computer to execute a process, the process comprising:
receiving, from a communications network, contents information which represents contents and is encrypted with an encryption key;
storing the received encrypted contents information;
transmitting, to the communications network, distribution request information indicating a distribution request for a decryption key required to decrypt the contents information, each time a request to output the stored contents information is input;
receiving, from the communications network, the decryption key which is requested by the distribution request information and transmitted in response to the distribution request information, and an encryption key used to perform an encryption process, which cannot be decrypted with the decryption key, for the contents information;
decrypting the encrypted contents information with the decryption key transmitted in response to the distribution request information, and outputting the contents information;
performing an encryption process for the contents information with the encryption key, which is received along with the decryption key transmitted in response to the distribution request information, after the contents information is output; and
again storing the contents information for which the encryption process is performed.

18. A computer data signal embodied in a carrier wave and representing a contents distributing program for causing a computer to execute a process, the process comprising:
transmitting, to a communications network, contents information and advertisement information which respectively represent contents and an advertisement, and are encrypted with an encryption key; and
transmitting, to the communications network, an encryption key used to perform an encryption process, which cannot be decrypted with a decryption key, for the contents information and the advertisement information along with the decryption key requested by a distribution request in response to the distribution request for the decryption key required to decrypt the encrypted contents information and advertisement information, wherein
an encryption process using the encryption key, which is received from the communications network along with the decryption key, is repeatedly performed by a number of times, which corresponds to a number of repetition times that the contents information is output, for the contents information and the advertisement information, which are transmitted to the communications network, and the encrypted contents information and advertisement information are stored, after the contents information and the advertisement information are decrypted with the decryption key received from the communications network, and the contents information is output in a reception terminal which receives the contents information and the advertisement information, and
in the reception terminal, the advertisement information is output, and the number of repetition times when the encryption process is repeatedly performed for the contents information is reduced, when an instruction to allow the advertisement information to be output is input.

19. A computer data signal embodied in a carrier wave and representing a contents distributing program for causing a computer to execute a process, the process comprising:
receiving, from a communications network, contents information and advertisement information which respectively represent contents and an advertisement, and are encrypted with an encryption key;
storing the received encrypted contents information and advertisement information;
transmitting, to the communications network, distribution request information indicating a distribution request for a decryption key required to decrypt the stored contents information and advertisement information;
receiving, from the communications network, the decryption key which is requested by the distribution request information and transmitted in response to the distribution request information, and an encryption key used to perform an encryption process, which cannot be decrypted with the decryption key, for the contents information;
decrypting the encrypted contents information with the decryption key transmitted in response to the distribution request information, and outputting the contents information;
repeatedly performing an encryption process using the encryption key, which is received along with the decryption key, for the contents information by a number of times, which corresponds to a number of repetition times that the contents information is output, after the contents information is output; and
again storing the contents information for which the encryption process is performed, wherein
the advertisement information is output, and the number of repetition times that the encryption process is performed for the contents information is reduced, when an instruction to allow the advertisement information to be output is input.

20. A contents distributing device, comprising:
contents information transmitting means for transmitting, to a communications network, contents information which represents contents and is encrypted with an encryption key;
first key transmitting means for transmitting, to the communications network, an encryption key used to perform an encryption process, which cannot be decrypted with a decryption key, for the contents information along with the decryption key requested by a distribution request in response to the distribution request for the decryption key required to decrypt the encrypted contents information; and
second key transmitting means for transmitting, to the communications network, an encryption key used to perform an encryption process, which cannot be decrypted with a decryption key, for the contents information along with the decryption key requested by a distribution request, each time information indicating the distribution request for the decryption key required to decrypt the contents information, for which the encryption process is performed with the encryption key transmitted to the communications network, is received, wherein
an encryption process using the encryption key, which is received from the communications network along with the decryption key, is again performed for the contents information transmitted to the communications network, and the contents information is stored in a reception terminal, after the contents information is decrypted with the decryption key received from the communications network, and output in the reception terminal which receives the contents information.

21. A contents outputting device, comprising:
contents information receiving means for receiving, from a communications network, contents information which represents contents and is encrypted with an encryption key;
first storing means for storing the received encrypted contents information;
key distribution request transmitting means for transmitting, to the communications network, distribution request information indicating a distribution request for a decryption key required to decrypt the contents information, each time a request to output the stored contents information is input;
key receiving means for receiving, from the communications network, the decryption key which is requested by the distribution request information and transmitted in response to the distribution request information, and an encryption key used to perform an encryption process, which cannot be decrypted with the decryption key, for the contents information;
contents outputting means for decrypting the encrypted contents information with the decryption key transmitted in response to the distribution request information, and for outputting the contents information;
encryption processing means for performing an encryption process for the contents information with the encryption key, which is received along with the decryption key transmitted in response to the distribution request information, after the contents information is output; and
second storing means for again storing the contents information for which the encryption process is performed.

22. A contents distributing device, comprising:
contents/advertisement information transmitting means for transmitting, to a communications network, contents information and advertisement information which respectively represent contents and an advertisement, and are encrypted with an encryption key; and
key transmitting means for transmitting, to the communications network, an encryption key used to perform an encryption process, which cannot be decrypted with a decryption key, for the contents information and the advertisement information along with the decryption key requested by a distribution request in response to the distribution request for the decryption key required to decrypt the encrypted contents information and advertisement information, wherein
an encryption process using the encryption key received from the communications network along with the decryption key is repeatedly performed by a number of times, which corresponds to a number of repetition times that the contents information is output, for the contents information and the advertisement information, which are transmitted to the communications network, and the encrypted contents information and advertisement information are stored, after the contents information and the advertisement information are decrypted with the decryption key received from the communications network, and the contents information is output in a reception terminal which receives the contents information and the advertisement information, and
in the reception terminal, the advertisement information is output, and the number of repetition times when the encryption process is repeatedly performed for the contents information is reduced, when an instruction to allow the advertisement information to be output is input.

23. A contents outputting device, comprising:
contents/advertisement information receiving means for receiving, from a communications network, contents information and advertisement information which respectively represent contents and an advertisement, and are encrypted with an encryption key;
first storing means for storing the received encrypted contents information and advertisement information;
key distribution request transmitting means for transmitting, to the communications network, distribution request information indicating a distribution request for a decryption key required to decrypt the stored contents information and advertisement information;
key receiving means for receiving, from the communications network, the decryption key which is requested by the distribution request information and transmitted in response to the distribution request information, and an encryption key used to perform an encryption process, which cannot be decrypted with the decryption key, for the contents information;
contents outputting means for decrypting the encrypted contents information with the decryption key transmitted in response to the distribution request information, and for outputting the contents information;
encryption processing means for repeatedly performing an encryption process using the encryption key, which is received along with the decryption key, for the contents information by a number of times, which corresponds to a number of repetition times that the contents information is output, after the contents information is output;
second storing means for again storing the contents information for which the encryption process is performed; and
outputting/controlling means for outputting the advertisement information, and for reducing the number of repetition times that the encryption process is performed for the contents information, when an instruction to allow the advertisement information to be output is input.
